(19) United States
(12) Patent Application Publication
(10) Pub. No.: US 2019/0020505 A1
(43) Pub. Date: Jan. 17, 2019

(54) EFFICIENT SOUNDING FOR MU-MIMO BEAMFORMERS

(71) Applicant: QUALCOMM Incorporated, San Diego, CA (US)

(72) Inventors: Houston Hoffman, San Diego, CA (US); Rajeev Kumar, San Diego, CA (US)

(21) Appl. No.: 15/650,798

(22) Filed: Jul. 14, 2017

(51) Int. Cl. H04L 25/02; H04B 7/06; H04B 7/0452; H04B 7/04; H04L 1/16

(52) U.S. Cl. CPC H04L 25/0228; H04B 7/0617; H04L 1/1685; H04B 7/0626; H04B 7/0421; H04B 7/0452

(57) ABSTRACT

Methods, systems, and devices for wireless communication are described. A beamformer may determine a parameter value for each of multiple beamformees and compare each of the determined parameter values to a stationary metric to identify a first subset of the beamformee devices that satisfy the stationary metric and a second subset of the beamformee devices that fail to satisfy the stationary metric. The beamformer may determine not to perform a sounding procedure with each beamformee device in the first subset and to perform the sounding procedure with each beamformee device in the second subset. The beamformer may generate a targeted sounding announcement that includes a plurality of identifiers that respectively correspond to each beamformee device in the second subset and transmit the targeted sounding announcement to initiate the sounding procedure with each beamformee device in the second subset.

### BACKGROUND

The following relates generally to wireless communication, and more specifically to efficient sounding for MU-MIMO beamformers.

Wireless communications systems are widely deployed to provide various types of communication content such as voice, video, packet data, messaging, broadcast, and so on. These systems may be multiple-access systems capable of supporting communication with multiple users by sharing the available system resources (e.g., time, frequency, and power). A wireless network, for example a wireless local area network (WLAN), such as a Wi-Fi (i.e., Institute of Electrical and Electronics Engineers (IEEE) 802.11) network may include an access point (AP) that may communicate with one or more stations (STAs) or mobile devices. The AP may be coupled to a network, such as the Internet, and may enable a mobile device to communicate via the network (or communicate with other devices coupled to the access point). A wireless device may communicate with a network device bi-directionally. For example, in a WLAN, a STA may communicate with an associated AP via downlink (DL) and uplink (UL). The DL (or forward link) may refer to the communication link from the AP to the station, and the UL (or reverse link) may refer to the communication link from the station to the AP.

Multi-user multiple-input multiple-output (MU-MIMO) (e.g., as defined by the IEEE 802.11ac specification) is a technique where multiple STAs, each with potentially multiple antennas, simultaneously transmit, receive, or both, independent data streams. MU-MIMO allows a first device having multiple antennas to transmit several data streams to multiple other devices at the same time, over the same frequency channel. MU-MIMO takes advantage of beamforming to send frames to spatially diverse locations at the same time.

Beamforming is a transmission method that focuses energy toward a receiver, such as a STA. Any device that steers transmitted frames is called a beamformer, and a receiver of such frames is called a beamformee. An AP and a STA may be either a beamformer or a beamformee. Beamforming uses an antenna array to dynamically focus energy of an emitted signal in a particular direction. In beamforming, a radio communication channel is measured to determine how to best use the available transmit power to reach a STA. In a WLAN, the AP, STA, or both may employ a sounding procedure for measuring the radio communication channel therebetween. The beamformer calculates a steering matrix using the channel measurement. The steering matrix is a mathematical description of how to focus transmitted energy toward the beamformee. The beamformer applies the steering matrix to steer energy of an emitted signal in the direction of the beamformee. The beamformer may periodically perform the sounding procedure for updating the steering matrix over time due to changes in the location of the beamformee and/or channel conditions. Conventional beamforming techniques, however, inefficiently perform the sounding process.

### SUMMARY

The described techniques relate to improved methods, systems, devices, or apparatuses that support efficient sounding for MU-MIMO beamformers. The techniques described herein selectively update a steering matrix of a beamformee based at least in part on the age of an existing steering matrix and whether a beamformee is determined to be relatively stationary. The beamformer may be a MU-MIMO beamformer that simultaneously communicates with multiple beamformees. Initially, the beamformer performs a sounding procedure with each beamformee and calculates a steering matrix for each beamformee. Subsequently, the beamformer may perform a sounding procedure only with a subset of beamformees that have a sufficiently old steering matrix and/or do not satisfy a stationary metric. Once the beamformee subset has been identified, the beamformer may send a targeted sounding announcement to all of the beamformees that only includes identifiers of beamformees in the subset. Any beamformee that does not find its identifier in the targeted sounding announcement may ignore the sounding procedure and optionally may enter a low power state. For beamformees with identifiers in the targeted sounding announcement, the beamformer may perform a sounding procedure with those beamformees. The beamformer may then update steering matrices for each beamformee in the subset based at least in part on results of the sounding procedure. In subsequent communications, the beamformer may respectively use the updated steering matrices for communicating with the corresponding members of the beamformee subset. For the relatively stationary beamformees, the beamformer may use the previously generated steering matrices.

A method of wireless communication is described. The method may include determining a parameter value for each of a plurality of beamformee devices, comparing each of the determined parameter values to a stationary metric to identify a first subset of the beamformee devices that satisfy the stationary metric and a second subset of the beamformee devices that fail to satisfy the stationary metric, determining not to perform a sounding procedure with each beamformee device in the first subset and to perform the sounding procedure with each beamformee device in the second subset, generating a targeted sounding announcement that includes a plurality of identifiers that respectively correspond to each beamformee device in the second subset, and transmitting the targeted sounding announcement to initiate the sounding procedure with each beamformee device in the second subset.

An apparatus for wireless communication is described. The apparatus may include means for determining a parameter value for each of a plurality of beamformee devices, means for comparing each of the determined parameter values to a stationary metric to identify a first subset of the beamformee devices that satisfy the stationary metric and a second subset of the beamformee devices that fail to satisfy the stationary metric, means for determining not to perform a sounding procedure with each beamformee device in the first subset and to perform the sounding procedure with each beamformee device in the second subset, means for generating a targeted sounding announcement that includes a plurality of identifiers that respectively correspond to each beamformee device in the second subset, and means for transmitting the targeted sounding announcement to initiate the sounding procedure with each beamformee device in the second subset.

Another apparatus for wireless communication is described. The apparatus may include a processor, memory in electronic communication with the processor, and instructions stored in the memory. The instructions may be operable to cause the processor to determine a parameter value for each of a plurality of beamformee devices, compare each of the determined parameter values to a stationary metric to identify a first subset of the beamformee devices that satisfy the stationary metric and a second subset of the beamformee devices that fail to satisfy the stationary metric, determine not to perform a sounding procedure with each beamformee device in the first subset and to perform the sounding procedure with each beamformee device in the second subset, generate a targeted sounding announcement that includes a plurality of identifiers that respectively correspond to each beamformee device in the second subset, and transmit the targeted sounding announcement to initiate the sounding procedure with each beamformee device in the second subset.

A non-transitory computer-readable medium for wireless communication is described. The non-transitory computer-readable medium may include instructions operable to cause a processor to determine a parameter value for each of a plurality of beamformee devices, compare each of the determined parameter values to a stationary metric to identify a first subset of the beamformee devices that satisfy the stationary metric and a second subset of the beamformee devices that fail to satisfy the stationary metric, determine not to perform a sounding procedure with each beamformee device in the first subset and to perform the sounding procedure with each beamformee device in the second subset, generate a targeted sounding announcement that includes a plurality of identifiers that respectively correspond to each beamformee device in the second subset, and transmit the targeted sounding announcement to initiate the sounding procedure with each beamformee device in the second subset.

Some examples of the method, apparatus, and non-transitory computer-readable medium described above may further include processes, features, means, or instructions for receiving a sounding response from a beamformee device of the second subset. Some examples of the method, apparatus, and non-transitory computer-readable medium described above may further include processes, features, means, or instructions for updating a steering matrix based at least in part on the sounding response. Some examples of the method, apparatus, and non-transitory computer-readable medium described above may further include processes, features, means, or instructions for communicating with the beamformee device of the second subset using the updated steering matrix.

Some examples of the method, apparatus, and non-transitory computer-readable medium described above may further include processes, features, means, or instructions for generating a steering matrix for a first beamformee device of the plurality of beamformee devices. Some examples of the method, apparatus, and non-transitory computer-readable medium described above may further include processes, features, means, or instructions for determining not to update the steering matrix based at least in part on the first beamformee device satisfying the stationary metric. Some examples of the method, apparatus, and non-transitory computer-readable medium described above may further include processes, features, means, or instructions for communicating with the first beamformee device using the steering matrix subsequent to completion of the sounding procedure.

Some examples of the method, apparatus, and non-transitory computer-readable medium described above may further include processes, features, means, or instructions for determining that a time period may have elapsed since the steering matrix was generated. Some examples of the method, apparatus, and non-transitory computer-readable medium described above may further include processes, features, means, or instructions for generating a second targeted sounding announcement that includes an identifier of the first beamformee device. Some examples of the method, apparatus, and non-transitory computer-readable medium described above may further include processes, features, means, or instructions for communicating the second targeted sounding announcement to initiate a second sounding procedure with the first beamformee device.

Some examples of the method, apparatus, and non-transitory computer-readable medium described above may further include processes, features, means, or instructions for determining a second parameter value for each of the plurality of beamformee devices. Some examples of the method, apparatus, and non-transitory computer-readable medium described above may further include processes, features, means, or instructions for comparing each of the second parameter values to the stationary metric to identify that all of the beamformee devices satisfy the stationary metric. Some examples of the method, apparatus, and non-transitory computer-readable medium described above may further include processes, features, means, or instructions for increasing a sounding interval to delay when a second sounding procedure may be initiated based at least in part on identifying that all of the beamformee devices satisfy the stationary metric.

Some examples of the method, apparatus, and non-transitory computer-readable medium described above may further include processes, features, means, or instructions for applying an exponential backoff algorithm for determining the increase to the sounding interval. In some examples of the method, apparatus, and non-transitory computer-readable medium described above, the increase to the sounding interval may be based at least in part on a defined amount or a factor of the defined amount.

Some examples of the method, apparatus, and non-transitory computer-readable medium described above may further include processes, features, means, or instructions for generating an initial sounding announcement that includes an identifier of each of the beamformee devices. Some examples of the method, apparatus, and non-transitory computer-readable medium described above may further include processes, features, means, or instructions for calculating a steering matrix for each of the beamformee devices.

Some examples of the method, apparatus, and non-transitory computer-readable medium described above may further include processes, features, means, or instructions for tracking a rate of change of each of the steering matrices and a downlink packet error rate of each of the beamformee devices. In some examples, the determined parameter values correspond to a rate of change of a steering matrix of the steering matrices and a downlink packet error rate of respective ones of the beamformee devices. In some examples, the parameter value corresponds to a rate of change of a steering matrix, or a downlink packet error rate, or channel feedback, or an age of the steering matrix, or any combination thereof. In some examples, the stationary metric corresponds to a rate of change threshold of a steering matrix, or a downlink packet error rate threshold, or a data rate threshold, or a signal to noise ratio threshold, or a layer threshold, or an age of the steering matrix threshold, or any combination thereof.

Some examples of the method, apparatus, and non-transitory computer-readable medium described above may further include processes, features, means, or instructions for determining whether the first subset of beamformee devices satisfies the stationary metric based at least in part on a rate of change of a steering matrix, or a downlink packet error rate, or channel feedback, or an age of a steering matrix, or any combination thereof.

Some examples of the method, apparatus, and non-transitory computer-readable medium described above may further include processes, features, means, or instructions for adjusting when to perform a second sounding procedure based at least in part on determining that a first beamformee device of the beamformee devices of the first subset no longer satisfies the stationary metric. In some examples of the method, apparatus, and non-transitory computer-readable medium described above, adjusting when to perform on the second sounding procedure further comprises immediately triggering of the second sounding procedure. In some examples of the method, apparatus, and non-transitory computer-readable medium described above, adjusting when to perform on the second sounding procedure further comprises decreasing a sounding interval.

### BRIEF DESCRIPTION OF THE DRAWINGS

FIG. 1 illustrates an example of a system for wireless communication that supports efficient sounding for MU-MIMO beamformers in accordance with aspects of the present disclosure.

FIG. 2 illustrates an example of a wireless communication system that supports efficient sounding for MU-MIMO beamformers in accordance with aspects of the present disclosure.

FIG. 3 illustrates an example of a swim lane diagram that supports efficient sounding for MU-MIMO beamformers in accordance with aspects of the present disclosure.

FIG. 4 illustrates an example of a swim lane diagram that supports efficient sounding for MU-MIMO beamformers in accordance with aspects of the present disclosure.

FIG. 5 illustrates an example of a targeted sounding announcement that supports efficient sounding for MU-MIMO beamformers in accordance with aspects of the present disclosure.

FIGS. 6 through 8 show block diagrams of a device that supports efficient sounding for MU-MIMO beamformers in accordance with aspects of the present disclosure.

FIG. 9 illustrates a block diagram of a system including a AP that supports efficient sounding for MU-MIMO beamformers in accordance with aspects of the present disclosure.

FIGS. 10 through 12 illustrate methods for efficient sounding for MU-MIMO beamformers in accordance with aspects of the present disclosure.

### DETAILED DESCRIPTION

Techniques are described for efficient sounding by a beamformer. Conventional sounding techniques inefficiently congest a radio communication channel and inefficiently consume beamformee power. The techniques described herein selectively update a steering matrix of a beamformee based at least in part on the age of an existing steering matrix and whether the beamformee is determined to be relatively stationary. The beamformer may be a MU-MIMO beamformer that simultaneously communicates with multiple beamformees. Initially, the beamformer performs a sounding procedure with each beamformee and calculates a steering matrix for each beamformee. Subsequently, the beamformer may perform a sounding procedure only with a subset of beamformees that have a sufficiently old steering matrix and/or do not satisfy a stationary metric. Once the beamformee subset has been identified, the beamformer may send a targeted sounding announcement to all of the beamformees that only includes identifiers of beamformees in the subset. Any beamformee that does not find its identifier in the targeted sounding announcement may ignore the sounding procedure and optionally may enter a low power state. For beamformees with identifiers in the targeted sounding announcement, the beamformer may perform a sounding procedure with those beamformees. The beamformer may then update steering matrices for each beamformee in the subset based at least in part on results of the sounding procedure. In subsequent communications, the beamformer may respectively use the updated steering matrices for communicating with the corresponding members of the beamformee subset. For the relatively stationary beamformees, the beamformer may use the previously generated steering matrices.

There are several benefits to collectively managing a group of beamformees. First, the beamformer may send a targeted sounding announcement to the group of beamformees, instead of sending individually-addressed sounding announcements to each of the beamformees that have to respond to such targeted sounding announcements. Sending a targeted sounding announcement to the group significantly reduces channel congestion and lowers data overhead as compared to sending individually-addressed sounding announcements. For instance, a beamformer may only have to reserve a channel a single time for sending the group a targeted sounding announcement, instead of having to reserve the channel for an extended time period and/or multiple times, and hence is competing less with the beamformees for channel resources. All beamformees connected to an AP that use a particular frequency band similarly benefit by having a less congested channel, and hence may have additional transmit opportunities on the channel to transmit data and perform the sounding procedure without competing with transmission of individually-addressed sounding announcements to stationary beamformees. Moreover, a stationary beamformee that lacks any data to transmit may monitor for and receive the targeted sounding announcement, without contributing any traffic to the channel due to having to respond to an individual sounding announcement. Further, the stationary beamformee may achieve significant power savings over conventional solutions, particularly when lacking data to transmit on the channel. For instance, a stationary beamformee may monitor for a targeted sounding announcement sent at known times, and may power down between sounding announcement transmissions when lacking data to transmit on the channel or when waiting for a scheduled transmission opportunity.

Aspects of the disclosure are initially described in the context of a wireless communications system. The wireless communications system may provide sounding techniques that efficiently utilize beamformee power and channel bandwidth. Aspects of the disclosure are further illustrated by and described with reference to apparatus diagrams, system diagrams, and flowcharts that relate to efficient sounding for MU-MIMO beamformers.

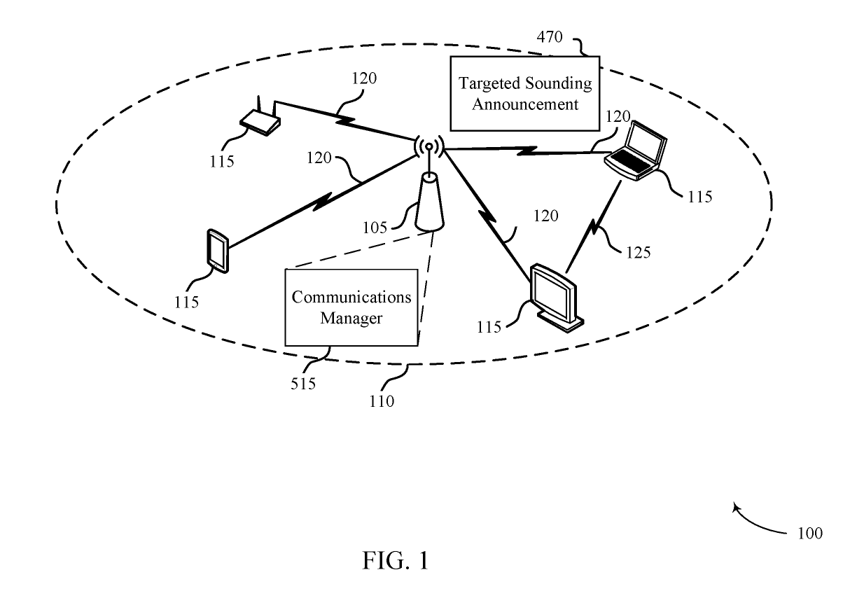

FIG. 1 illustrates a wireless local area network (WLAN) 100 (also known as a Wi-Fi network) configured in accordance with various aspects of the present disclosure. The WLAN 100 may include an AP 105 and multiple associated STAs 115, which may represent devices such as mobile stations, personal digital assistant (PDAs), other handheld devices, netbooks, notebook computers, tablet computers, laptops, display devices (e.g., TVs, computer monitors, etc.), printers, etc. The AP 105 and the associated stations 115 may represent a basic service set (BSS) or an extended service set (ESS). The various STAs 115 in the network are able to communicate with one another through the AP 105. Also shown is a coverage area 110 of the AP 105, which may represent a basic service area (BSA) of the WLAN 100. An extended network station (not shown) associated with the WLAN 100 may be connected to a wired or wireless distribution system that may allow multiple APs 105 to be connected in an ESS. In accordance with the examples provided herein, an AP 105 may operate as a beamformer communicating with multiple beamformees, such as STAs 115. A STA 115 may also operate as a beamformer communicating with multiple beamformees, such as other STAs 115 and/or AP 105.

Although not shown in FIG. 1, a STA 115 may be located in the intersection of more than one coverage area 110 and may associate with more than one AP 105. A single AP 105 and an associated set of STAs 115 may be referred to as a BSS. An ESS is a set of connected BSSs. A distribution system (not shown) may be used to connect APs 105 in an ESS. In some cases, the coverage area 110 of an AP 105 may be divided into sectors (also not shown). The WLAN network 100 may include APs 105 of different types (e.g., metropolitan area, home network, etc.), with varying and overlapping coverage areas 110. Two STAs 115 may also communicate directly via a direct wireless link 125 regardless of whether both STAs 115 are in the same coverage area 110. Examples of direct wireless links 120 may include Wi-Fi Direct connections, Wi-Fi Tunneled Direct Link Setup (TDLS) links, and other group connections. STAs 115 and APs 105 may communicate according to the WLAN radio and baseband protocol for physical and MAC layers from IEEE 802.11 and versions including, but not limited to, 802.11b, 802.11g, 802.11a, 802.11n, 802.11ac, 802.11ad, 802.11ah, 802.11ax, etc. In other implementations, peer-to-peer connections or ad hoc networks may be implemented within WLAN network 100.

In some cases, a STA 115 (or an AP 105) may be detectable by a central AP 105, but not by other STAs 115 in the coverage area 110 of the central AP 105. For example, one STA 115 may be at one end of the coverage area 110 of the central AP 105 while another STA 115 may be at the other end. Thus, both STAs 115 may communicate with the AP 105, but may not receive the transmissions of the other.

The example embodiments may provide for improved power and channel utilization by reducing how frequently sounding is performed with beamformees that satisfy a stationary metric. A beamformer, such as AP 105, may perform a sounding procedure more frequently with non-stationary STAs 115 and less frequently with relatively stationary STAs 115. Advantageously, the example sounding techniques may reduce the amount of traffic on a radio communication channel and may save power of relatively stationary beamformees that do not have to participate in as many soundings.

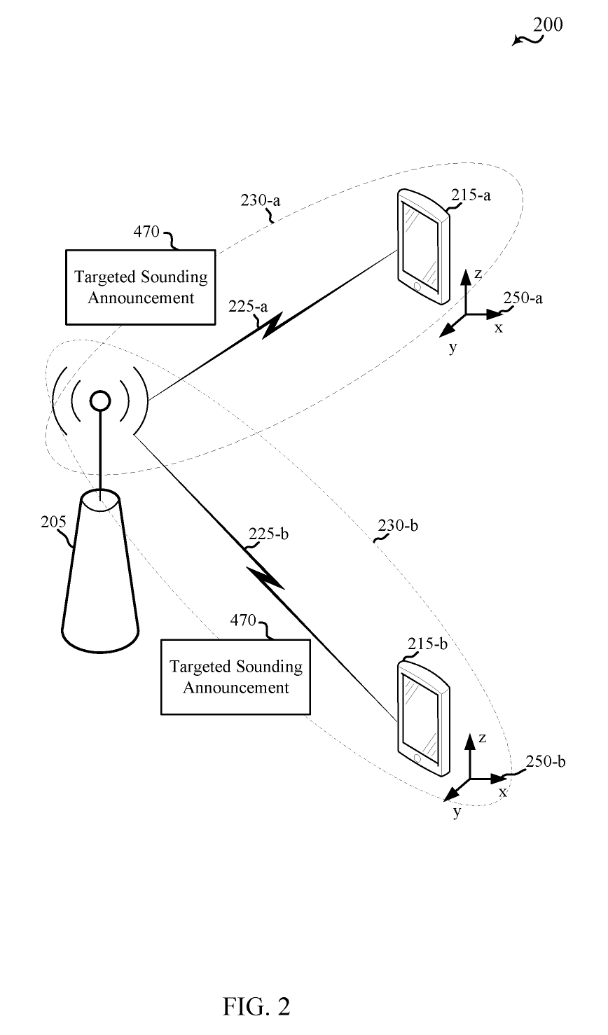

FIG. 2 illustrates an example of a wireless communications system 200 for efficient sounding for MU-MIMO beamformers. The wireless communications system 200 includes an access point (AP) 205 and one or more stations (STA) 215. The communications system 100 may correspond to a multi-user multiple-input multiple-output (MU-MIMO) wireless network (e.g., as defined by the IEEE 802.11ac specification). In the depicted example, AP 205 may operate as a beamformer and the STAs 215-a, 215-b may operates as beamformees. In other examples, a STA 215-a may operates as a beamformee and AP 205, STA 215-b may operate as beamformees. Other devices may operate as a beamformer and various device combinations may operate as beamformees.

AP 205 may optimize communications with the STAs 215 by focusing energy of transmitted signals (e.g., as a beam of energy) in the direction of the STAs 215 in a technique known as beamforming. Beamforming allows a station to transmit multiple simultaneous data streams to one or multiple stations. Beamforming techniques are employed by a transmitting station to steer signals based on knowledge of a communication channel to improve reception.

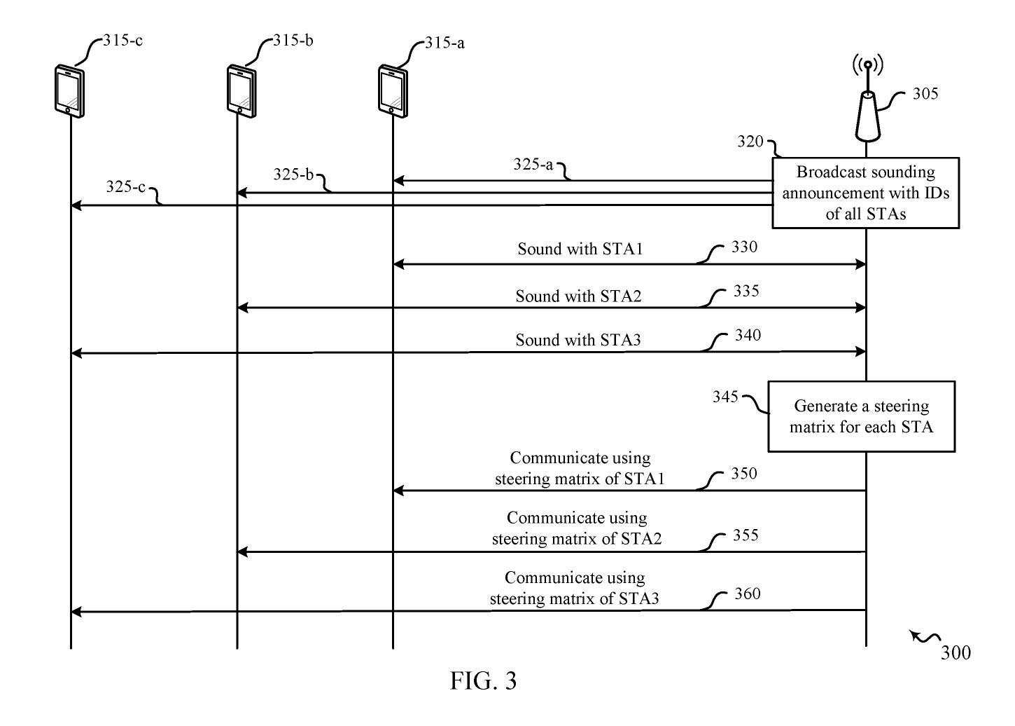

The AP 205 may use a sounding procedure to determine a relative location of the STA 215, and thus the direction in which to direct a beamforming signal 225. A location of a STA 215 may change over time, as represented by arrows 250-a and 250-b, and the sounding procedure may be performed so that the beamforming signal 225 is steered in the appropriate direction. Sounding denotes the process performed by a beamformer (e.g., the AP in a downlink transmission) to acquire channel state information (CSI) from each beamformee (e.g., the STAs 215 in a downlink transmission). To do so, the AP 205 sends a sounding frame that may include one or more training symbols to a beamformee (e.g., STA 215-a)(see FIG. 3 at 330, 335, 340) and waits for the beamformee STA 215-a to provide feedback containing a measure of the radio communication channel. For example, the STA 215 may calculate a feedback vector based at least in part on channel feedback determined using the received training symbols and return the feedback vector to the AP 205. The AP 205 uses the feedback vector to calculate a steering matrix that will be used to pre-code data to steer beamforming signal 225-a in direction 230-a toward STA 215-a and beamforming signal 225-b in direction 230-b toward STA 215-b. When there are multiple beamformees, the AP 205 may calculate a steering matrix for each beamformee.

Conventional sounding techniques waste power of the beamformee and over-utilize the communication channel. In conventional MU-MIMO beamforming, a beamformer performs sounding about every ten milliseconds. Frequent sounding is wasteful of power particularly when a beamformee STA is not moving quickly or at all. A laptop beamformee, for example, may remain on a user's desk for long periods of time. Frequent sounding may drain the laptop's battery, especially, when not plugged into an electrical socket or other power source.

The following describes a beamformer AP performing an initial sounding procedure with beamformee STAs associated therewith to establish initial steering matrices followed by selectively performing a sounding procedure to limit which of the steering matrices are updated.

FIG. 3 illustrates an example of a swim lane diagram 300 for efficient sounding for MU-MIMO beamformers. AP 305 is an example of APs 105, 205, and STA 315 is an example of STA 115, 215. The AP 305 may perform a sounding procedure to generate an initial steering matrix for each of STAs 315-a, 315-b, and 315-c.

At 320, AP 305 may broadcast a sounding announcement to each of the STAs 315-a, 315-b, and 315-c (see arrows 325-a, 325-b, and 325-c). The sounding announcement may be, for example, a null data packet (NDP) sounding announcement. The sounding announcement may contain an identifier of the AP 305 (e.g., network address) and an identifier of each of the STAs 315-a, 315-b, and 315-c associated with the AP 305. The announcement notifies the STAs 315-a, 315-b, and 315-c that each should be ready to prepare a channel report. Thereafter, respectively at 330, 335, and 340, AP 305 may perform sounding with STA1 315-a, STA2 315-b, and STA3 315-c.

Sounding may involve the AP 305 transmitting a sounding frame to each STA 315 to sound the channel. The sounding frame may include an identifier of a particular STA that is to provide a current channel measurement and respond with a feedback vector that includes the current channel measurement. After receiving the sounding frame, a STA 315 prepares and sends a feedback vector to the AP 305. The feedback vector may be used to provide the AP 305 with an estimate of the channel over which it is transmitting. The estimate may be generated based at least in part on implicit feedback, explicit feedback, or both.

To generate implicit feedback, the beamformee STA 315 communicates one or more training symbols to the beamformer AP 305. The beamformer AP 305 generates CSI for the channel between the beamformer AP 305 and beamformee STA 315 based at least in part on the received training symbols, and uses the CSI to generate a steering matrix. To generate explicit feedback, the beamformer AP 305 sends training symbols to the beamformee STA 315, and the beamformee STA 315 estimates the channel to generate CSI based at least in part on the received training symbols. The beamformee STA 315 sends the CSI to the beamformer AP 305 for generation of a steering matrix based at least in part on the CSI.

At 345, the beamformer AP 305 may generate a steering matrix for each of the STAs 315 based at least in part on the CSI. Thereafter, the beamformer AP 305 may communicate with a beamformee STA 315 using the steering matrix generated for that beamformee STA. At 350, for example, beamformer AP 305 may communicate with beamformee STA1 315-a using a first steering matrix, beamformer AP 305 may, at 355, communicate with beamformee STA2 315-b using a second steering matrix, and beamformer AP 305 may, at 360, communicate with beamformee STA3 315-c using a third steering matrix.

Locations of the STAs and channel conditions may change over time, and a beamformer AP may determine when to update a steering matrix for each STA to efficiently utilize channel bandwidth and beamformee power.

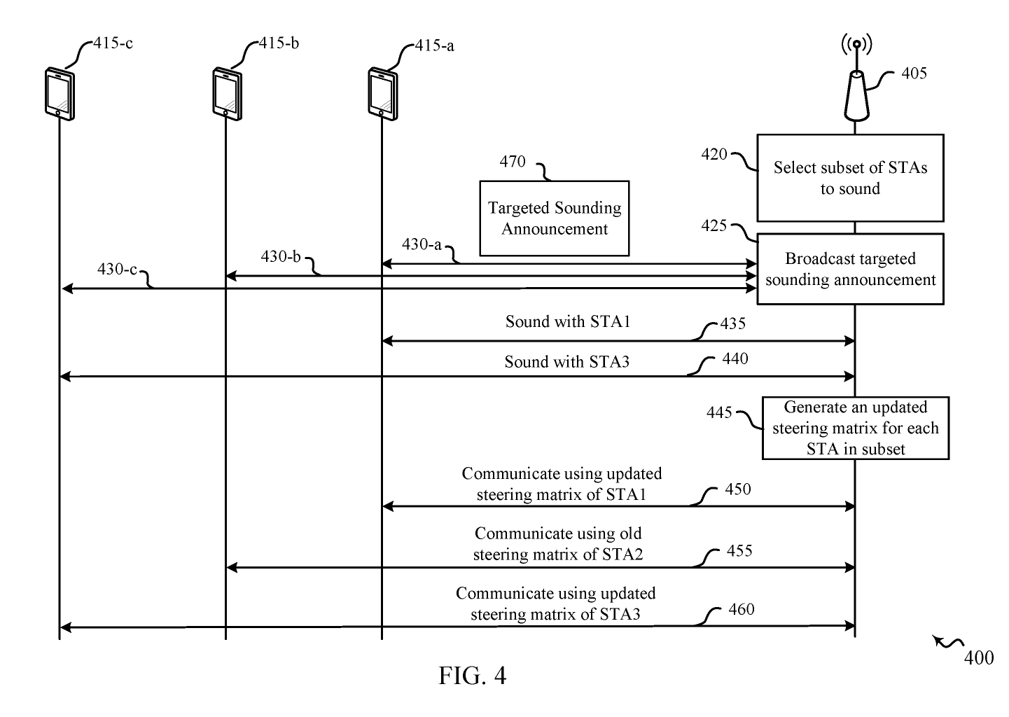

FIG. 4 illustrates an example of a swim lane diagram 400 for selectively updating steering matrices for efficient sounding for MU-MIMO beamformers. The swim lane diagram 400 may be used for selectively updating steering matrices. AP 405 is an example of APs 105, 205, 305, and STA 415 is an example of STA 115, 215, 315.

At 420, beamformer AP 405 may select a subset of the beamformee STAs to sound. The selection may be based at least in part on age of a previously generated steering matrix and a value of one or more parameters. Channel conditions may vary over time and the beamformer AP 405 may at least periodically perform a sounding procedure with each beamformee STA to update a steering matrix to account for changes in channel conditions. When a steering matrix is created for a particular beamformee STA, the beamformer AP 405 may generate a time stamp to indicate the time of creation. The AP 405 may select a beamformee STA to sound based at least in part on determining that a difference between a current time and the time stamp does not satisfy an age threshold (e.g., difference exceeds the age threshold indicating that at least a time period has elapsed since the steering matrix was generated).

Beamformer AP 405 may also determine values of one or more parameters for assessing whether a particular beamformee STA is relatively stationary. A stationary beamformee STA is not moving, is moving slowly, or tends to be at the same general location, and hence reusing an existing beamforming matrix often provides adequate performance. To avoid congesting a communication channel and inefficiently consuming beamformee STA power, the beamformer AP 405 may sound with non-stationary beamformee STAs more often than relatively stationary beamformee STAs. The beamformer AP 405 may measure values of one or more parameters to determine whether a beamformee STA is relatively stationary.

The AP 405 may determine that a beamformer STA is relatively stationary if values of one or more parameters satisfy one or more metrics. Examples of parameters include packet error rate, rate of change in a steering matrix, dropping of sequential packets, and implicit channel feedback.

In an example, the AP 405 may monitor a value of a downlink packet error rate (PER) for assessing whether a STA is relatively stationary. To generate PER data, the AP 405 may utilize a steering matrix to transmit packets to a STA, and the STA 415 may respond with an acknowledgment (ACK) or a negative acknowledgement (NACK). The ACK may indicate that a STA successfully received a transmitted packet, and the NACK may indicate that the STA did not successfully receive and/or decode a transmitted packet. The AP 405 may monitor what percentage of packets receive ACKs, and respectively compare the percentage associated with each STA 415 to a stationary metric. For example, the stationary metric may be a threshold percentage. If the percentage of packets that receive ACKs for a STA 415 meets or exceeds the threshold percentage (e.g., 99% or more receive ACKs), the AP 405 determine that the STA 415 satisfies the stationary metric. Otherwise, the AP 405 determines that the STA 415 does not satisfy the stationary metric. Determining that a STA satisfies a stationary metric does not suggest or require that the STA be immobile, and instead permits the STA to changes positions and/or move around by a certain amount.

In a further example, the AP 405 may monitor dropping of sequential packets for determining whether a STA satisfies a stationary metric. The AP 405 may include a sequentially increasing number in each packet transmitted to a STA 415. The STA 415 may send an acknowledgement (ACK) or a negative acknowledgement (NACK) depending on whether the STA 415 successfully received and decoded a packet or group of packets. The AP 405 may monitor if one or more NACKs are received for rolling packet sequences, and respectively compare the number of sequential packets not successfully acknowledged by each STA 415 to a stationary metric. In this example, the stationary metric may be a sequential dropped packet threshold. If the AP 405 determines that the number of sequential packets not successfully acknowledged by a STA 415 is less than or equal to the sequential dropped packet threshold (e.g., 10 or fewer sequential packets were dropped), the AP 405 determines that the STA 415 satisfies the stationary metric. Otherwise, the AP 405 determines that the STA 415 does not satisfy the stationary metric.

In another example, the AP 405 may track a steering matrix rate of change a parameter value for determining whether a STA satisfies a stationary metric. A steering matrix may include a number of rows and columns and each entry at a particular row/column combination may be referred to as an element. Below is a simplified example of a 3×3 matrix A, having elements aₓ, a_{y}, a_{z}, bₓ, and so forth.

$$A = \vert \begin{matrix}{a}_{x} & {a}_{y} & {a}_{z} \\ {b}_{x} & {b}_{y} & {b}_{z} \\ {c}_{x} & {c}_{y} & {c}_{z}\end{matrix} \vert$$

The value of each element (e.g., aₓ) is a weight that the AP 405 uses to control in what direction to steer a signal. The AP 405 may monitor changes in the value of each weight for determining whether a STA satisfies a stationary metric. For example, the stationary metric may be a rate of change threshold, and the AP 405 may respectively compare the percentage changes in the values of each weight for each STA 415 to the rate of change threshold. If the value of all weights for a STA 415 changes by less than or equal to the rate of change threshold (e.g., weights change by 20% or less), the AP 405 determines that the STA 415 satisfies the stationary metric. Otherwise, if the value of one or more weights changes by more than the rate of change threshold (e.g., weight changes by more than 20%), the AP 405 determines that the STA 415 does not satisfy the stationary metric.

In another example, the AP 405 may monitor implicit channel feedback for determining whether a STA satisfies a stationary metric. The AP 405 may generate channel state information (CSI) based at least in part on the implicit channel feedback, as described above. Examples of CSI include a Channel Quality Indicator (CQI), a precoding matrix indicator (PMI), and a rank indication (RI). CQI indicates a maximum data rate the STA can support with a block error ratio of 10% or less based at least in part on current channel conditions. PMI indicates the precoding matrix that AP 405 is to apply before transmitting a signal to a STA. The AP 405 selects one of multiple precoding matrices to maximize a signal to noise (SNR) ratio at the STA. RI indicates the number of layers that STA can successfully receive and ranges between 1 and the number of antenna ports of the AP 405.

In an example, the AP 405 may monitor CQI for determining the maximum data rate a STA can support for determining whether the STA satisfies a stationary metric. For example, the stationary metric may be a data rate threshold, and the AP 405 may respectively compare the maximum supported data rates of each STA 415 to the data rate threshold. If the maximum supported data rate of a STA 415 equals or exceeds the data rate threshold, the AP 405 determines that the STA 415 satisfies the stationary metric. Otherwise, the AP 405 determines that the STA 415 does not satisfy the stationary metric.

In another example, the AP 405 may monitor PMI for determining a maximum SNR estimate at a STA for determining whether the STA satisfies a stationary metric. For example, the stationary metric may be an SNR threshold, and the AP 405 may respectively compare the maximum SNR estimate for each STA to the SNR threshold. If the maximum SNR estimate for a STA 415 equals or exceeds the SNR threshold, the AP 405 determines that the STA 415 satisfies the stationary metric. Otherwise, the AP 405 determines that the STA 415 does not satisfy the stationary metric.

In a further example, the AP 405 may monitor RI for determining the number of layers that a STA can receive for determining whether the STA satisfies a stationary metric. For example, the stationary metric may be a layer threshold, and the AP 405 may respectively compare the determined number of layers for each STA to the layer threshold. If the number of layers for a STA 415 equals or exceeds the layer threshold, the AP 405 determines that the STA 415 satisfies the stationary metric. Otherwise, the AP 405 determines that the STA 415 does not satisfy the stationary metric.

The AP 405 may also use multiple parameter values in combination for assessing whether a STA satisfies a stationary metric. In an example, AP 405 may normalize the values of the parameters, and apply a function, weighted or unweighted, to combine the normalized values for calculating a normalized output of the function. The AP 405 may utilize a value of the normalized output for assessing whether a STA satisfies a stationary metric. For example, the stationary metric may be a threshold and the function may be an average of the normalized values. The AP 405 may respectively compare the average of the normalized values for each STA to the threshold. If the average for a STA 415 equals or exceeds the threshold, the AP 405 determines that the STA 415 satisfies the stationary metric. Otherwise, the AP 405 determines that the STA 415 does not satisfy the stationary metric.

In some examples, the AP 405 may select at least a subset of STAs for sounding that have a steering matrix that is too old and/or are determined to not satisfy a stationary metric.

At 425, the AP 405 may broadcast a targeted sounding announcement 470 that includes identifiers of the selected subset of the beamformee STAs 415 to initiate a sounding procedure. Each beamformee STA 415 associated with the AP 405 may receive the targeted sounding announcement 470 (see 430-a, 430-b, 430-c), and the sounding announcement may be sent periodically, aperiodically, at specified intervals, or the like.

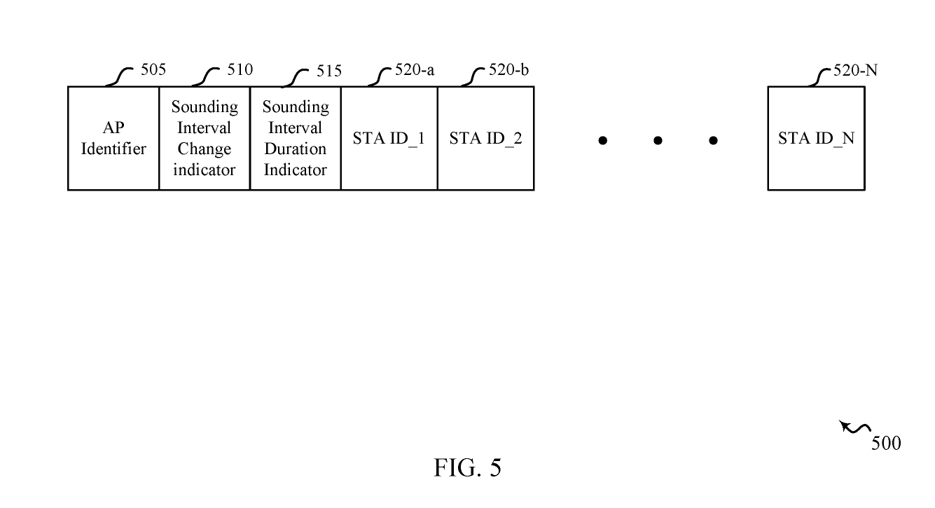

FIG. 5 shows a diagram 600 of a targeted sounding announcement 470 that supports efficient sounding for MU-MIMO beamformers in accordance with various aspects of the present disclosure. The targeted sounding announcement 470 may include an AP identifier 505, a sounding interval change indicator 510, a sounding interval duration indicator 515, and zero or more station identifiers 520. In some examples, the AP 405 may use beamforming techniques to communicate beams in the direction of each STA 415, and may omnidirectionally transmit the targeted sounding announcement 470 so that it may be received by each of the STAs 415 regardless of direction. The AP identifier 505 may identify which AP transmitted the targeted sounding announcement 470 to enable the STAs 415 to determine whether the targeted sounding announcement 470 was sent by an AP to which the STAs 415 are connected. The sounding interval change indicator 510 may be one or more bits to indicate whether the AP 405 has changed the duration of a sounding interval. In some examples, the AP 405 may increase the duration if all STAs 415 are determined to be relatively stationary, and the AP 405 may increase the duration up to a maximum value. In some examples, the AP 405 may shorten the duration if all STAs 415 are determined to be non-stationary, and the AP 405 may shorten the duration up to a minimum value (e.g., indicate that the AP 405 is immediately triggering a sounding procedure). The sounding interval duration indicator 515 may indicate the duration of the sounding interval currently being used to sound with the STAs 415. The STAs 415 may process the sounding interval duration indicator 515 to determine when to expect the AP 405 to transmit the targeted sounding announcement 470. If a STA 415 enters a low power mode (e.g., a sleep mode), the STA 415 may use the value specified in the sounding interval duration indicator 515 to determine when to wake up to receive the targeted sounding announcement 470.

The targeted sounding announcement 470 may include zero or more station identifiers 520. A station identifier 520 may uniquely identify one of the STAs 415. The AP 405 includes a station identifier 520 of a particular STA 415 to indicating that the AP 405 is initiating a sounding procedure with that STA 415. If the targeted sounding announcement 470 does not include any station identifiers 520, the AP 405 may be transmitting the targeted sounding announcement 470 to, for example, adjust the length of the sounding interval due to determining that all of the STAs 415 are relatively stationary. In some cases, the AP 405 may define a common station identifier 520 to indicate that the AP 405 is initiating sounding with all of the STAs 415. In other examples, the AP 405 may associate some of the STAs 415 with a group and corresponding group station identifier 520. The AP may transmit the group station identifier 520 to indicate that the AP 405 is initiating sounding with all STAs 415 that are members of the group.

In some examples, an order of the station identifiers 520 within the targeted sounding announcement 470 may convey information to the STAs 415. For instance, the targeted sounding announcement 470 may include N station identifiers 520-a, 520-b, . . . , 520-N, where N is a positive integer. The AP 405 may determine a rate of movement of each of the STAs 415, and the order of the station identifiers 520 within the targeted sounding announcement 470 may correspond to the rate of movement. A station identifier 520 of a STA 415 having a highest rate of movement may be listed first in the targeted sounding announcement 470, followed by a station identifier 520 of a STA 415 having a next highest rate of movement, and so forth until listing a station identifier 520 of a STA 415 having a lowest rate of movement. The order of the N station identifiers 520-a, 520-b, . . . , 520-N within the targeted sounding announcement 470 may indicate the order in which the AP 405 may sound with the respective STAs 415. In some examples, the AP 405 may scramble the order of the station identifiers 520 within the targeted sounding announcement 470 and provide the STAs 415 with a descrambling rule. The STAs 415 may apply the descrambling rule to determine the order in which the AP 405 may sound with the respective STAs 415

Upon receipt of the targeted sounding announcement 470, a beamformee STA 415 may process the targeted sounding announcement to determine whether its identifier is included in the announcement. If not included, a beamformee STA 415 may ignore a remainder of the sounding procedure (e.g., enter a sleep mode or reduced power mode if not actively communicating). If included, a beamformee STA 415 may monitor for the AP 405 to sound the channel. In this example, the AP 405 may select STAs 415-a and 415-c for sounding, but not STA 415-b.

At 435, the AP 405 may communicate a sounding frame to STA 415-a and may receive a sounding response from STA 415-a. The sounding response may be, for example, a feedback vector, one or more training symbols, or the like. In an example, STA 415-a may receive the sounding frame, calculate a feedback vector, and communicate the feedback vector to the AP 405. In another example, the sounding frame may be an NDP packet including one or more training symbols that the STA 415-a may use to measure the communication channel. In some examples, the STA 415-a may communicate one or more training symbols to AP 405 for providing implicit channel feedback.

Similarly, at 440, the AP 405 may communicate a sounding frame to STA 415-c. STA 415-c may receive the sounding frame, calculate a feedback vector, and communicate the feedback vector to the AP 405. In some examples, the STA 415-b may communicate one or more training symbols to AP 405 for providing implicit channel feedback.

At 445, the AP 405 may calculate an updated steering matrix for each STA in the subset. For example, the AP 405 may calculate a steering matrix for STA 415-a based at least in part on the feedback vector received from STA 415-a and/or the implicit channel feedback. The AP 405 may similarly calculate a steering matrix for STA 415-c. Updating a steering matrix may include calculating a new steering matrix based at least in part on a feedback vector and/or the implicit channel feedback. Updating a steering matrix may also include changing less than all weights in a previously generated steering matrix based at least in part on a feedback vector and/or the implicit channel feedback. The AP 405 may skip updating a steering matrix for STA 415-b because, as noted above, the AP 405 has determined that the STA 415-b satisfies a stationary metric and an age threshold. Once the AP 405 has updated the steering matrices and/or determined not to update one or more steering matrices, the sounding procedure may be complete.

In subsequent communications, as shown at 450, 455, and 460, the AP 405 may use an updated steering matrix for transmitting to STA 415-a, a previously generated steering matrix for transmitting to STA 415-b, and an updated steering matrix for transmitting to STA 415-c.

The operations depicted in swim lane diagram 400 may repeat one or more times. For example, the AP 405 may constantly, periodically, or sporadically monitor parameter values and respective ages of the steering matrices for selecting a subset of STAs to sound, at 420. Thereafter, the AP 405 may sound with the STA subset in the manner described in swim lane diagram 400.

In some instances, the AP 405 may, at 420, determine that all STAs satisfy a stationary metric (e.g., using current values of one or more parameters) and an age threshold. In such a scenario, the AP 405 may increase a sounding interval (and thus sound less often). In one example, the AP 405 may use values of the parameters as inputs to a backoff algorithm for determining a size of the increase. In another example, the AP 405 may use an exponential backoff algorithm for determining a size of the increase. Using an exponential backoff algorithm may be particularly beneficial for rapidly increasing the sounding interval, and thus may rapidly reduce congestion caused by sounding and may dramatically increase power savings of the associated STAs 415. In some examples, the AP 405 may limit how frequently to apply the exponential backoff algorithm. For example, the AP 405 may maintain historical data on how often each STA 415 is determined to be stationary. In an example, the AP 405 may apply the exponential backoff algorithm when the historical data indicates that all of the STAs 415 have been found to satisfy a stationary metric after expiration of consecutive, or two or more, age thresholds without updating the steering matrix for any of the STAs 415. In some examples, the AP 405 may increase the sounding interval by a defined amount or a factor of defined amount A (where A is a configurable value). The procedures for increasing a sounding interval for all STAs may also be used to determine the amount to increase the sounding interval for a particular STA that is determined to satisfy a stationary metric and an age threshold.

When the AP 405 determines that one or more STAs no longer satisfies a stationary metric, the AP 405 may decrease the sounding interval (e.g., shorten the time between soundings) or immediately trigger a sounding procedure with the one or more STAs (e.g., send a second or subsequent targeted sounding announcement that includes one or more identifiers of the one or more STAs). The AP 405 may determine that one or more STAs no longer satisfies a stationary metric based at least on part on current values of the parameters, as discussed above. In some examples, the decease of the sounding interval for a group of STA 415 may occur rapidly or slowly, depending on current values of the parameters. In an example, the AP 405 may determine that a parameter value for a particular STA 415 fails to satisfy a stationary metric be less than a defined amount (e.g., less than a 10% different between the parameter value and the stationary metric). Rather than immediately triggering a sounding procedure, the AP 405 may linearly decrease the sounding interval. Conversely, if the AP 405 determines that a parameter value for a particular STA 415 fails to satisfy a stationary metric by more than a defined amount (e.g., equal to or greater than a 10% different between the parameter value and the stationary metric). the AP 405 may exponentially decrease the sounding interval or immediately trigger a sounding procedure with that or all STA 415. Beneficially, the duration of the sounding interval may be tailored to how far off the parameter value is from a stationary metric, thereby limiting channel congestion and power consumption.

The examples described herein provide a number of advantages. First, a beamformee that satisfies a stationary metric and/or has a sufficiently new steering matrix saves a significant amount of power by not having to respond to as many a sounding procedures. Second, channel congestion is significantly reduced by limiting sounding to beamformees that do not satisfy a stationary metric and/or have a sufficiently old steering matrix. Third, the beamformer may send a targeted sounding announcement to a group of beamformees, instead of sending individually-addressed sounding announcements to each of the beamformees that have to respond to such sounding announcements. Sending a targeted sounding announcement to the group significantly reduces channel congestion and lowers data overhead as compared to sending individually-addressed sounding announcements. For instance, a beamformer may only have to reserve a channel a single time for sending the targeted sounding announcement, instead of having to reserve the channel for an extended time period and/or multiple times, and hence is competing less with the beamformees for channel resources. All beamformees connected to an AP that use a particular frequency band similarly benefit by having a less congested channel, and hence may have additional transmit opportunities on the channel to transmit data and perform the sounding procedure without competing with transmission of individually-addressed sounding announcements to stationary beamformees. Moreover, a stationary beamformee that lacks any data to transmit may monitor for and receive the targeted sounding announcement, without contributing any traffic to the channel due to having to respond to an individual sounding announcement. Further, the stationary beamformee may achieve significant power savings over conventional solutions, particularly when lacking data to transmit on the channel. For instance, a stationary beamformee may monitor for a targeted sounding announcement sent at known times, and may power down between sounding announcement transmissions when lacking data to transmit on the channel or when waiting for a scheduled transmission opportunity.

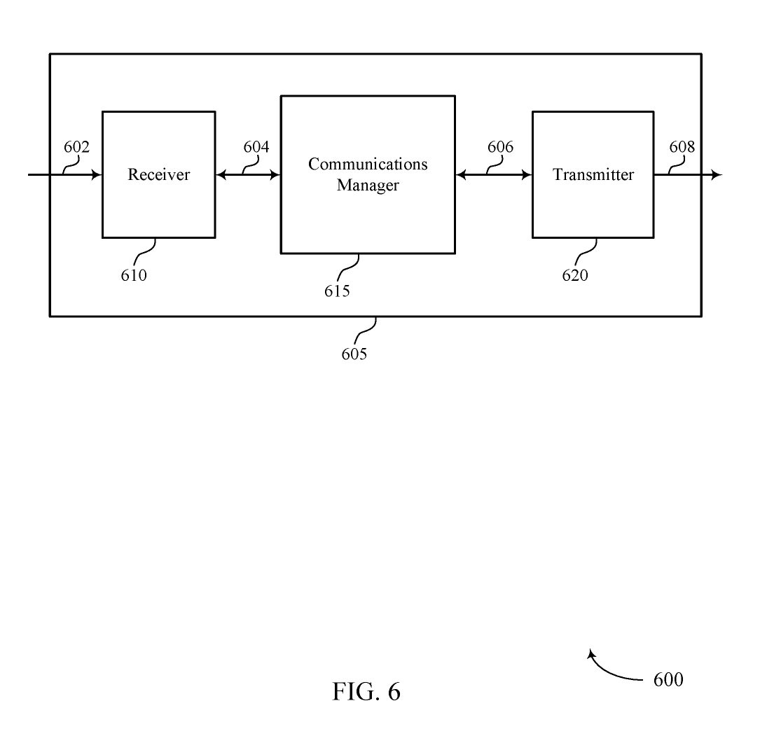

FIG. 6 shows a block diagram 600 of a wireless device 605 that supports efficient sounding for MU-MIMO beamformers in accordance with various aspects of the present disclosure. Wireless device 605 may be an example of aspects of a access point (AP) 105 or a STA 115 as described with reference to FIG. 1. Wireless device 605 may include receiver 610, communications manager 615, and transmitter 620. Wireless device 605 may also include a processor. Each of these components may be in communication with one another (e.g., via one or more buses). In an example, receiver 610, communications manager 615, and transmitter 620 may include a circuit or circuitry for performing the operations described herein.

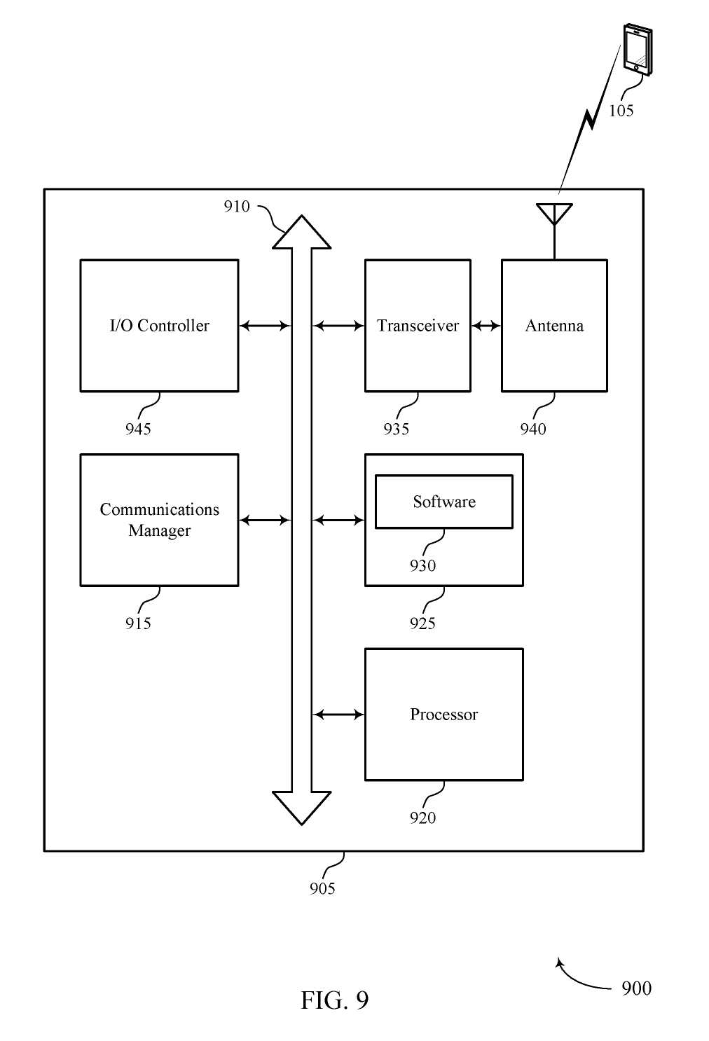

Receiver 610 may receive information such as packets, user data, or control information associated with various information channels via communication link 602 (e.g., control channels, data channels, and information related to efficient sounding for MU-MIMO beamformers, etc.). Information may be passed on to other components of the device. The receiver 610 may be an example of aspects of the transceiver 935 described with reference to FIG. 9.

Communications manager 615 may be an example of aspects of the communications manager 915 described with reference to FIG. 9. Communications manager 615 may be configure to analyze packets, user data, or control information associated with various information channels obtained from receiver 610 via communication link 604.

Communications manager 615 may determine a parameter value for each of a plurality of beamformee devices, compare each of the determined parameter values to a stationary metric to identify a first subset of the beamformee devices that satisfy the stationary metric and a second subset of the beamformee devices that fail to satisfy the stationary metric, determine not to perform a sounding procedure with each beamformee device in the first subset and to perform the sounding procedure with each beamformee device in the second subset, generate a targeted sounding announcement that includes a plurality of identifiers that respectively correspond to each beamformee device in the second subset, and transmit the targeted sounding announcement to initiate the sounding procedure with each beamformee device in the second subset.

Transmitter 620 may receive output from the communications manager 615 via communication link 606 and transmit signals generated by other components via communication link 608. In some examples, the transmitter 620 may be collocated with a receiver 610 in a transceiver. For example, the transmitter 620 may be an example of aspects of the transceiver 935 described with reference to FIG. 9. The transmitter 620 may include a single antenna, or it may include a set of antennas.

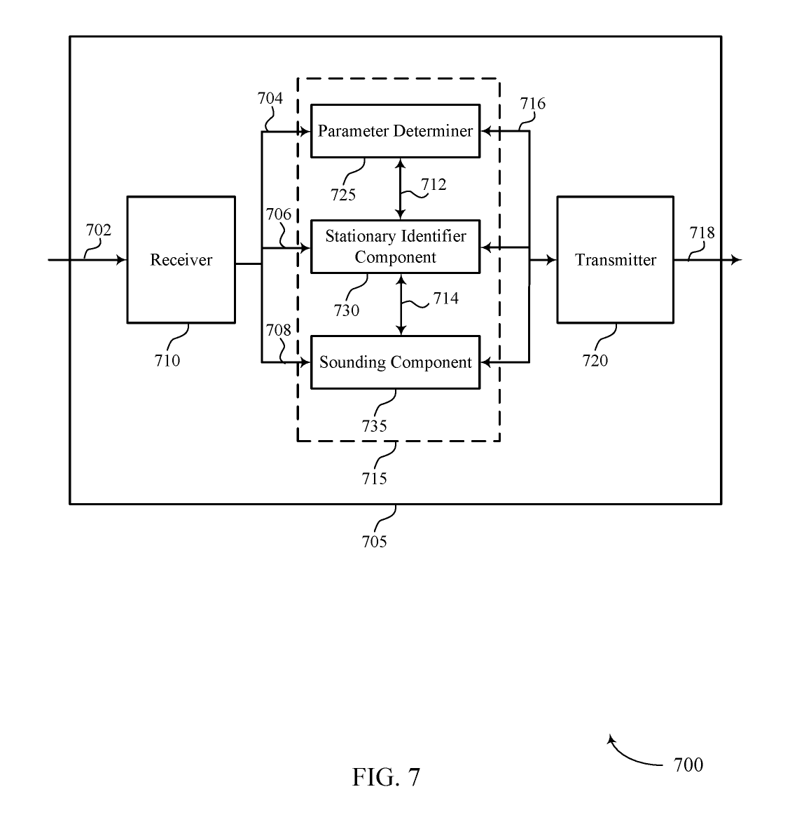

FIG. 7 shows a block diagram 700 of a wireless device 705 that supports efficient sounding for MU-MIMO beamformers in accordance with various aspects of the present disclosure. Wireless device 705 may be an example of aspects of a wireless device 605, a AP 105, or a STA 115 as described with reference to FIGS. 1 and 6. Wireless device 705 may include receiver 710, communications manager 715, and transmitter 720. Wireless device 705 may also include a processor. Each of these components may be in communication with one another (e.g., via one or more buses).

Receiver 710 may receive information such as packets, user data, or control information associated with various information channels via communication link 702 (e.g., control channels, data channels, and information related to efficient sounding for MU-MIMO beamformers, etc.). Information may be passed on to other components of the device, such as to the Parameter Determiner 725 via communication link 704, Stationary Identifier Component 730 via communication link 706, and Sounding Component 735 via communication link 708. The receiver 710 may be an example of aspects of the transceiver 935 described with reference to FIG. 9. In an example, receiver 710, communications manager 715, transmitter 720, Parameter Determiner 725, Stationary Identifier Component 730, and Sounding Component 735 may include a circuit or circuitry for performing the operations described herein.

Communications manager 715 may be an example of aspects of the communications manager 915 described with reference to FIG. 9. Communications manager 715 may receive packets, user data, or control information from receiver 710 via communication links 704, 706, and 708. Communications manager 715 may also receive packets, user data, or control information from other internal or external components. Communications manager 715 may internally communicate packets, user data, or control information between Parameter Determiner 725, Stationary Identifier Component 730, and Sounding Component 735 via communication links 712, 714, and 716. Communications manager 715 may output packets, user data, or control information to transmitter 720 via communication links 716. For example, Parameter Determiner 725 may output packets, user data, or control information to transmitter 720 via communication link 716, Stationary Identifier Component 730 may output packets, user data, or control information to transmitter 720 via communication link 716, and Sounding Component 735 may output packets, user data, or control information to transmitter 720 via communication link 716.

Parameter Determiner 725 may determine a parameter value for each of a set of beamformee devices and determine a second parameter value for each of the set of beamformee devices.

Stationary Identifier Component 730 may compare each of the determined parameter values to a stationary metric to identify a first subset of the beamformee devices that satisfy the stationary metric and a second subset of the beamformee devices that fail to satisfy the stationary metric. Stationary Identifier Component 730 may determine not to perform a sounding procedure with each beamformee device in the first subset and to perform the sounding procedure with each beamformee device in the second subset. Stationary Identifier Component 730 may determine whether the first subset of the beamformee devices satisfies the stationary metric based at least in part on: a rate of change of a steering matrix, or a downlink packet error rate, or channel feedback, or an age of the steering matrix, or any combination thereof. In some examples, the stationary metric corresponds to a rate of change threshold of a steering matrix, or a downlink packet error rate threshold, or a data rate threshold, or a signal to noise ratio threshold, or a layer threshold, or an age of the steering matrix threshold, or any combination thereof. Stationary Identifier Component 730 may compare each of the second parameter values to the stationary metric to identify that all of the beamformee devices satisfy the stationary metric, increase a sounding interval to delay when a second sounding procedure is initiated based on identifying that all of the beamformee devices satisfy the stationary metric, apply an exponential backoff algorithm for determining the increase to the sounding interval, and track a rate of change of each of the steering matrices and a downlink packet error rate of each of the beamformee devices. In some cases, the increase to the sounding interval is based on a defined amount or a factor of the defined amount. Stationary Identifier Component 730 may adjust when to perform a second sounding procedure based on determining that a first of the beamformee devices of the first subset no longer satisfies the stationary metric. In some cases, adjusting when to perform on the second sounding procedure further includes immediately triggering of the second sounding procedure. In some cases, adjusting when to perform on the second sounding procedure further includes decreasing a sounding interval.

Sounding Component 735 may generate an initial sounding announcement that includes an identifier of each of the beamformee devices, generate a targeted sounding announcement that includes a set of identifiers that respectively correspond to each beamformee device in the second subset, transmit the targeted sounding announcement to initiate the sounding procedure with each beamformee devices of the second subset, receive a sounding response from a beamformee device of the second subset, communicate with the beamformee device of the second subset using the updated steering matrix, communicate with the first beamformee device using the steering matrix subsequent to completion of the sounding procedure, generate a second targeted sounding announcement that includes an identifier of the first beamformee device, communicate the second targeted sounding announcement to initiate a second sounding procedure with the first beamformee device.

Transmitter 720 may transmit signals generated by other components of the device via communication link 718. In some examples, the transmitter 720 may be collocated with a receiver 710 in a transceiver. For example, the transmitter 720 may be an example of aspects of the transceiver 935 described with reference to FIG. 9. The transmitter 720 may include a single antenna, or it may include a set of antennas.

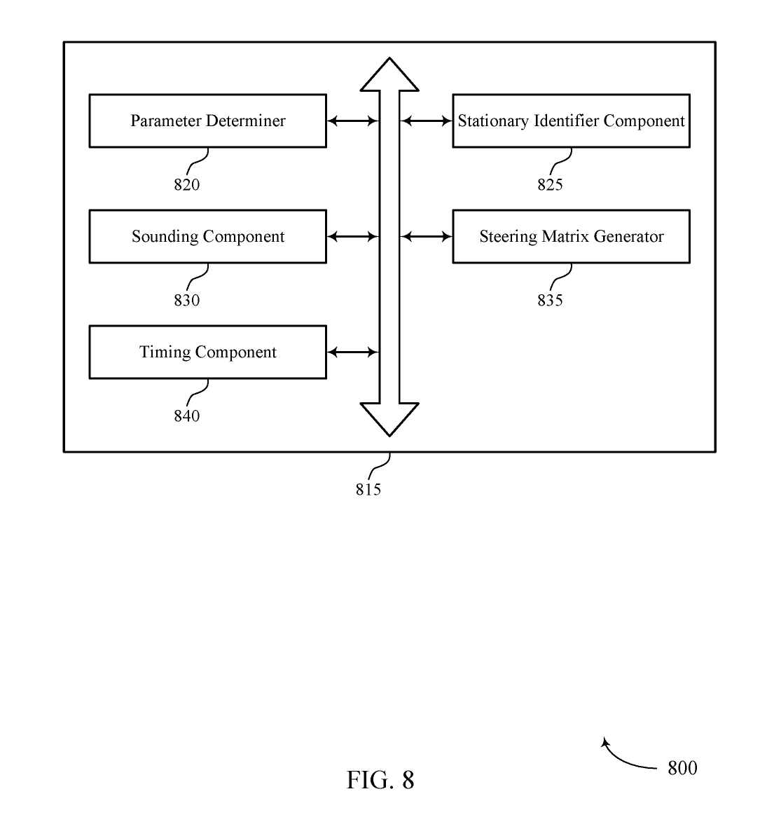

FIG. 8 shows a block diagram 800 of a communications manager 815 that supports efficient sounding for MU-MIMO beamformers in accordance with various aspects of the present disclosure. The communications manager 815 may be an example of aspects of a communications manager 615, a communications manager 715, or a communications manager 915 described with reference to FIGS. 6, 7, and 9. The communications manager 815 may include Parameter Determiner 820, Stationary Identifier Component 825, Sounding Component 830, Steering Matrix Generator 835, and Timing Component 840. Each of these components may communicate, directly or indirectly, with one another (e.g., via one or more buses) and, in an example, each may include a circuit or circuitry for performing the operations described herein.

Parameter Determiner 820 may determine a parameter value for each of a set of beamformee devices and determine a second parameter value for each of the set of beamformee devices.

Stationary Identifier Component 825 may compare each of the determined parameter values to a stationary metric to identify a first subset of the beamformee devices that satisfy the stationary metric and a second subset of the beamformee devices that fail to satisfy the stationary metric, determine not to perform a sounding procedure with each beamformee device in the first subset and to perform the sounding procedure with each beamformee device in the second subset, determine whether the first subset of beamformee devices satisfies the stationary metric based at least in part on: a rate of change of a steering matrix, or a downlink packet error rate, or channel feedback, or an age of the steering matrix, or any combination thereof. In some examples, the stationary metric corresponds to a rate of change threshold of a steering matrix, or a downlink packet error rate threshold, or a data rate threshold, or a signal to noise ratio threshold, or a layer threshold, or an age of the steering matrix threshold, or any combination thereof. Stationary Identifier Component 825 may compare each of the second parameter values to the stationary metric to identify that all of the beamformee devices satisfy the stationary metric, increase a sounding interval to delay when a second sounding procedure is initiated based on determining that all of the beamformee devices satisfy the stationary metric, apply an exponential backoff algorithm for determining the increase to the sounding interval, track a rate of change of each of the steering matrices and a downlink packet error rate of each of the beamformee devices. In some cases, the increase to the sounding interval is based on a defined amount or a factor of the defined amount. Stationary Identifier Component 825 may adjust when to perform a second sounding procedure based on determining that a first of the beamformee devices of the first subset no longer satisfies the stationary metric. In some cases, adjusting when to perform on the second sounding procedure further includes immediately triggering of the second sounding procedure. In some cases, adjusting when to perform on the second sounding procedure further includes decreasing a sounding interval.

Sounding Component 830 may generate a targeted sounding announcement that includes a set of identifiers that respectively correspond to each beamformee device in the second subset, transmit the targeted sounding announcement to initiate a sounding procedure with each beamformee device in the second subset, receive a sounding response from a beamformee device of the second subset, communicate with the beamformee device of the second subset using the updated steering matrix, communicate with the first beamformee device using the steering matrix subsequent to completion of the sounding procedure, generate a second targeted sounding announcement that includes an identifier of the first beamformee device, communicate the second targeted sounding announcement to initiate a second sounding procedure with the first beamformee device, and generate an initial sounding announcement that includes an identifier of each of the beamformee devices.

Steering Matrix Generator 835 may update a steering matrix based on the sounding response, generate a steering matrix for a first of the set of beamformee devices, determine not to update the steering matrix based on the first beamformee device satisfying the stationary metric, and calculate a steering matrix for each of the beamformee devices.

Timing Component 840 may determine that a time period has elapsed since the steering matrix was generated.

FIG. 9 shows a diagram of a system 900 including a device 905 that supports efficient sounding for MU-MIMO beamformers in accordance with various aspects of the present disclosure. Device 905 may be an example of or include the components of wireless device 605, wireless device 705, a AP 105, or STA 115 as described above, e.g., with reference to FIGS. 1, 6 and 7. Device 905 may include components for bi-directional voice and data communications including components for transmitting and receiving communications, including communications manager 915, processor 920, memory 925, software 930, transceiver 935, antenna 940, and I/O controller 945. These components may be in electronic communication via one or more busses (e.g., bus 910).

Processor 920 may include an intelligent hardware device, (e.g., a general-purpose processor, a digital signal processor (DSP), a central processing unit (CPU), a microcontroller, an application-specific integrated circuit (ASIC), an field-programmable gate array (FPGA), a programmable logic device, a discrete gate or transistor logic component, a discrete hardware component, or any combination thereof). In some cases, processor 920 may be configured to operate a memory array using a memory controller. In other cases, a memory controller may be integrated into processor 920. Processor 920 may be configured to execute computer-readable instructions stored in a memory to perform various functions (e.g., functions or tasks supporting efficient sounding for MU-MIMO beamformers).

Memory 925 may include random access memory (RAM) and read only memory (ROM). The memory 925 may store computer-readable, computer-executable software 930 including instructions that, when executed, cause the processor to perform various functions described herein. In some cases, the memory 925 may contain, among other things, a basic input/output system (BIOS) which may control basic hardware and/or software operation such as the interaction with peripheral components or devices.

Software 930 may include code to implement aspects of the present disclosure, including code to support efficient sounding for MU-MIMO beamformers. Software 930 may be stored in a non-transitory computer-readable medium such as system memory or other memory. In some cases, the software 930 may not be directly executable by the processor but may cause a computer (e.g., when compiled and executed) to perform functions described herein.

Transceiver 935 may communicate bi-directionally, via one or more antennas, wired, or wireless links as described above. For example, the transceiver 935 may represent a wireless transceiver and may communicate bi-directionally with another wireless transceiver. The transceiver 935 may also include a modem to modulate the packets and provide the modulated packets to the antennas for transmission, and to demodulate packets received from the antennas.

In some cases, the wireless device may include a single antenna 940. However, in some cases the device may have more than one antenna 940, which may be capable of concurrently transmitting or receiving multiple wireless transmissions.

I/O controller 945 may manage input and output signals for device 905. I/O controller 945 may also manage peripherals not integrated into device 905. In some cases, I/O controller 945 may represent a physical connection or port to an external peripheral. In some cases, I/O controller 945 may utilize an operating system such as iOS®, ANDROID®, MS-DOS®, MS-WINDOWS®, OS/2®, UNIX®, LINUX®, or another known operating system.

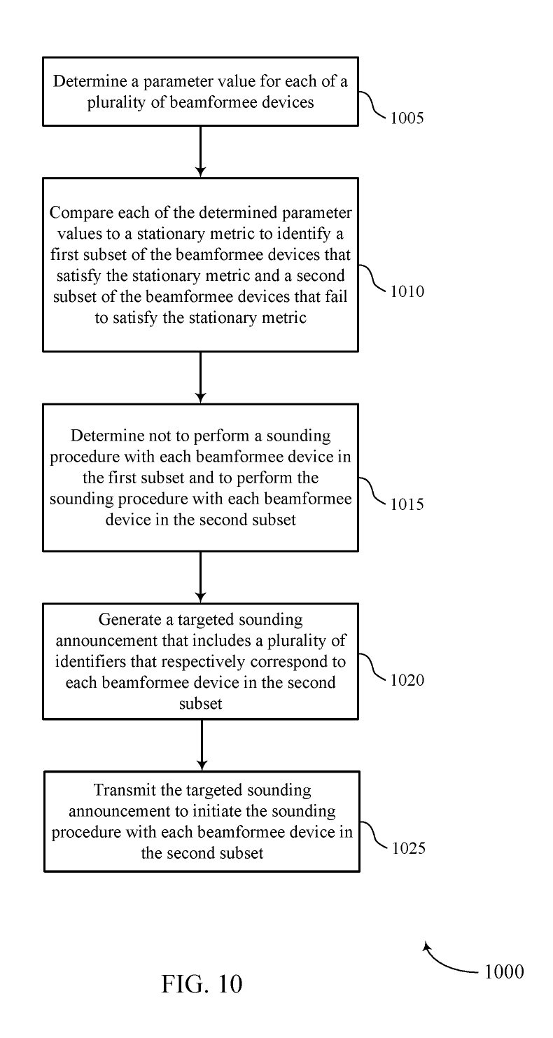

FIG. 10 shows a flowchart illustrating a method 1000 for efficient sounding for MU-MIMO beamformers in accordance with various aspects of the present disclosure. The operations of method 1000 may be implemented by a AP 105 or its components as described herein. For example, the operations of method 1000 may be performed by a communications manager as described with reference to FIGS. 6 through 9. In some examples, a AP 105 may execute a set of codes to control the functional elements of the device to perform the functions described below. Additionally or alternatively, the AP 105 may perform aspects the functions described below using special-purpose hardware. Additionally or alternatively, the STA 115 or its components as described herein may perform the operations of method 1000.

The method 1000 may provide for an AP 105 identifying which beamformee devices are not relatively stationary, and sending a targeted sounding announcement to inform the non-stationary beamformee devices that the AP 105 will be sounding with those beamformee devices. Sending a targeted sounding announcement to the group significantly reduces channel congestion and lowers data overhead as compared to sending individually-addressed sounding announcements.

At block 1005 the AP 105 may determine a parameter value for each of a plurality of beamformee devices. The operations of block 1005 may be performed according to the methods described with reference to FIGS. 1 through 4. In certain examples, aspects of the operations of block 1005 may be performed by a Parameter Determiner as described with reference to FIGS. 6 through 9.

At block 1010 the AP 105 may compare each of the determined parameter values to a stationary metric to identify a first subset of the beamformee devices that satisfy the stationary metric and a second subset of the beamformee devices that fail to satisfy the stationary metric. The operations of block 1010 may be performed according to the methods described with reference to FIGS. 1 through 4. In certain examples, aspects of the operations of block 1010 may be performed by a Stationary Identifier Component as described with reference to FIGS. 6 through 9.

At block 1015 the AP 105 may determine not to perform a sounding procedure with each beamformee device in the first subset and to perform the sounding procedure with each beamformee device in the second subset. The operations of block 1010 may be performed according to the methods described with reference to FIGS. 1 through 4. In certain examples, aspects of the operations of block 1010 may be performed by a Stationary Identifier Component as described with reference to FIGS. 6 through 9.

At block 1020 the AP 105 may generate a targeted sounding announcement that includes a plurality of identifiers that respectively correspond to each beamformee device in the second subset. The operations of block 1015 may be performed according to the methods described with reference to FIGS. 1 through 4. In certain examples, aspects of the operations of block 1015 may be performed by a Sounding Component as described with reference to FIGS. 6 through 9.

At block 1025 the AP 105 may transmit the targeted sounding announcement to initiate the sounding procedure with each beamformee device in the second subset. The operations of block 1020 may be performed according to the methods described with reference to FIGS. 1 through 4. In certain examples, aspects of the operations of block 1020 may be performed by a Sounding Component as described with reference to FIGS. 6 through 9.

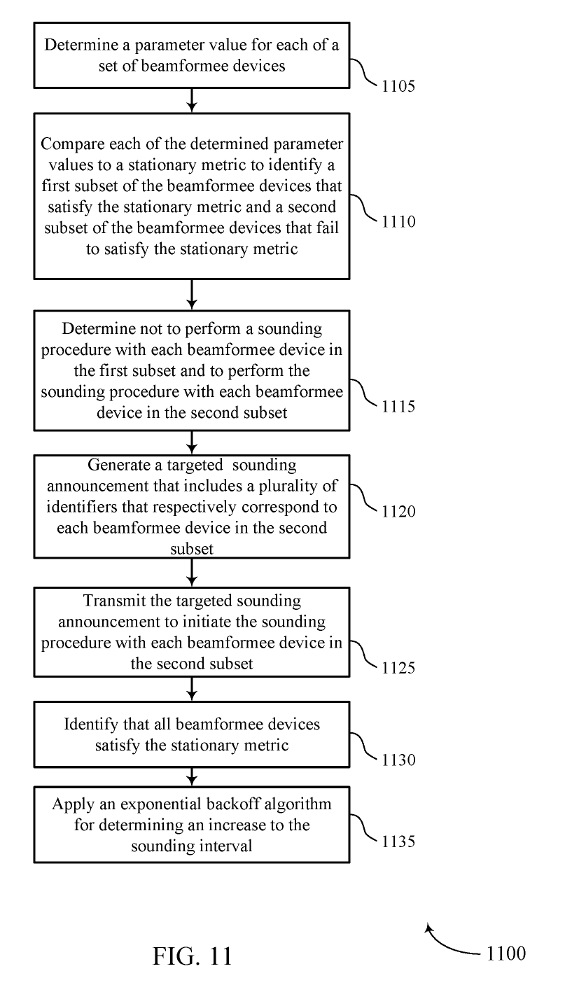

FIG. 11 shows a flowchart illustrating a method 1100 for efficient sounding for MU-MIMO beamformers in accordance with various aspects of the present disclosure. The operations of method 1100 may be implemented by a AP 105 or its components as described herein. For example, the operations of method 1100 may be performed by a communications manager as described with reference to FIGS. 6 through 9. In some examples, a AP 105 may execute a set of codes to control the functional elements of the device to perform the functions described below. Additionally or alternatively, the AP 105 may perform aspects the functions described below using special-purpose hardware. Additionally or alternatively, the STA 115 or its components as described herein may perform the operations of method 1100.

At block 1105 the AP 105 may determine a parameter value for each of a plurality of beamformee devices. The operations of block 1105 may be performed according to the methods described with reference to FIGS. 1 through 4. In certain examples, aspects of the operations of block 1105 may be performed by a Parameter Determiner as described with reference to FIGS. 6 through 9.

At block 1110 the AP 105 may compare each of the determined parameter values to a stationary metric to identify a first subset of the beamformee devices that satisfy the stationary metric and a second subset of the beamformee devices that fail to satisfy the stationary metric. The operations of block 1110 may be performed according to the methods described with reference to FIGS. 1 through 4. In certain examples, aspects of the operations of block 1110 may be performed by a Stationary Identifier Component as described with reference to FIGS. 6 through 9.

At block 1115 the AP 105 may determine not to perform a sounding procedure with each beamformee device in the first subset and to perform the sounding procedure with each beamformee device in the second subset. The operations of block 1110 may be performed according to the methods described with reference to FIGS. 1 through 4. In certain examples, aspects of the operations of block 1110 may be performed by a Stationary Identifier Component as described with reference to FIGS. 6 through 9.

At block 1120 the AP 105 may generate a targeted sounding announcement that includes a plurality of identifiers that respectively correspond to each beamformee device in the second subset. The operations of block 1115 may be performed according to the methods described with reference to FIGS. 1 through 4. In certain examples, aspects of the operations of block 1115 may be performed by a Sounding Component as described with reference to FIGS. 6 through 9.

At block 1125 the AP 105 may transmit the targeted sounding announcement to initiate the sounding procedure with each beamformee device in the second subset. The operations of block 1120 may be performed according to the methods described with reference to FIGS. 1 through 4. In certain examples, aspects of the operations of block 1120 may be performed by a Sounding Component as described with reference to FIGS. 6 through 9.

At block 1130 the AP 105 may identify that all beamformee devices satisfy the stationary metric. The operations of block 1125 may be performed according to the methods described with reference to FIGS. 1 through 4. In certain examples, aspects of the operations of block 1125 may be performed by a Stationary Identifier Component as described with reference to FIGS. 6 through 9.

At block 1135 the AP 105 may apply an exponential backoff algorithm for determining an increase to the sounding interval. The operations of block 1130 may be performed according to the methods described with reference to FIGS. 1 through 4. In certain examples, aspects of the operations of block 1130 may be performed by a Stationary Identifier Component as described with reference to FIGS. 6 through 9.

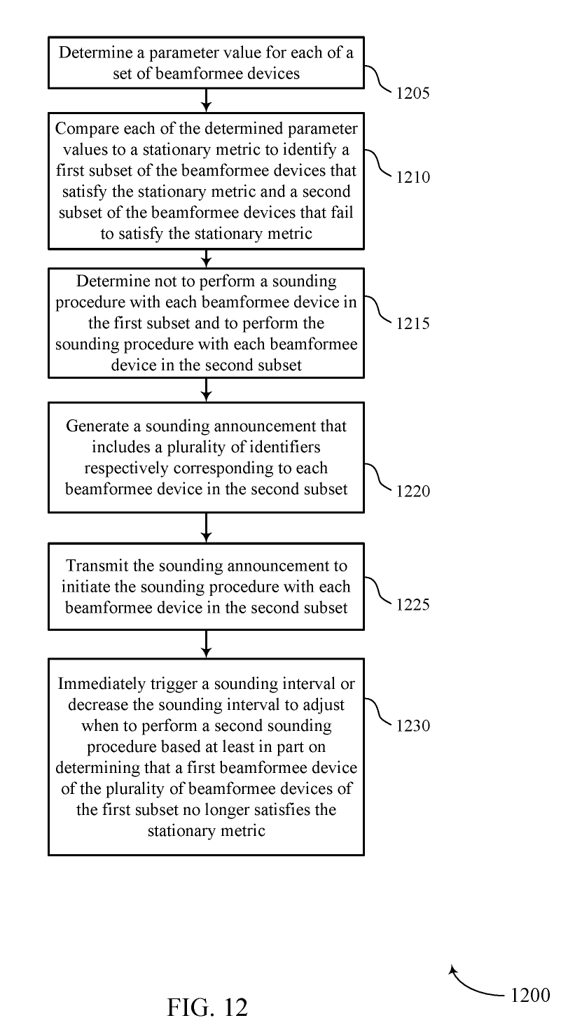

FIG. 12 shows a flowchart illustrating a method 1200 for efficient sounding for MU-MIMO beamformers in accordance with various aspects of the present disclosure. The operations of method 1200 may be implemented by a AP 105 or its components as described herein. For example, the operations of method 1200 may be performed by a communications manager as described with reference to FIGS. 6 through 9. In some examples, a AP 105 may execute a set of codes to control the functional elements of the device to perform the functions described below. Additionally or alternatively, the AP 105 may perform aspects the functions described below using special-purpose hardware. Additionally or alternatively, the STA 115 or its components as described herein may perform the operations of method 1200.

At block 1205 the AP 105 may determine a parameter value for each of a plurality of beamformee devices. The operations of block 1205 may be performed according to the methods described with reference to FIGS. 1 through 4. In certain examples, aspects of the operations of block 1205 may be performed by a Parameter Determiner as described with reference to FIGS. 6 through 9.

At block 1210 the AP 105 may compare each of the determined parameter values to a stationary metric to identify a first subset of the beamformee devices that satisfy the stationary metric and a second subset of the beamformee devices that fail to satisfy the stationary metric. The operations of block 1210 may be performed according to the methods described with reference to FIGS. 1 through 4. In certain examples, aspects of the operations of block 1210 may be performed by a Stationary Identifier Component as described with reference to FIGS. 6 through 9.

At block 1215 the AP 105 may determine not to perform a sounding procedure with each beamformee device in the first subset and to perform the sounding procedure with each beamformee device in the second subset. The operations of block 1210 may be performed according to the methods described with reference to FIGS. 1 through 4. In certain examples, aspects of the operations of block 1210 may be performed by a Stationary Identifier Component as described with reference to FIGS. 6 through 9.

At block 1220 the AP 105 may generate a targeted sounding announcement that includes a plurality of identifiers that respectively correspond to each beamformee device in the second subset. The operations of block 1215 may be performed according to the methods described with reference to FIGS. 1 through 4. In certain examples, aspects of the operations of block 1215 may be performed by a Sounding Component as described with reference to FIGS. 6 through 9.

At block 1225 the AP 105 may transmit the targeted sounding announcement to initiate the sounding procedure with each beamformee device in the second subset. The operations of block 1220 may be performed according to the methods described with reference to FIGS. 1 through 4. In certain examples, aspects of the operations of block 1220 may be performed by a Sounding Component as described with reference to FIGS. 6 through 9.

At block 1230 the AP 105 may immediately trigger a sounding interval or decrease the sounding interval to adjust when to perform a second sounding procedure based at least in part on determining that a first beamformee device of the plurality of beamformee devices of the first subset no longer satisfies the stationary metric. The operations of block 1225 may be performed according to the methods described with reference to FIGS. 1 through 4. In certain examples, aspects of the operations of block 1225 may be performed by a Stationary Identifier Component as described with reference to FIGS. 6 through 9.

It should be noted that the methods described above describe possible implementations, and that the operations and the steps may be rearranged or otherwise modified and that other implementations are possible. Furthermore, aspects from two or more of the methods may be combined.

Techniques described herein may be used for various wireless communications systems such as code division multiple access (CDMA), time division multiple access (TDMA), frequency division multiple access (FDMA), orthogonal frequency division multiple access (OFDMA), single carrier frequency division multiple access (SC-FDMA), and other systems. The terms “system” and “network” are often used interchangeably. A time division multiple access (TDMA) system may implement a radio technology such as Global System for Mobile Communications (GSM). An orthogonal frequency division multiple access (OFDMA) system may also be implemented.

The wireless communications system or systems described herein may support synchronous or asynchronous operation. For synchronous operation, the stations may have similar frame timing, and transmissions from different stations may be approximately aligned in time. For asynchronous operation, the stations may have different frame timing, and transmissions from different stations may not be aligned in time. The techniques described herein may be used for either synchronous or asynchronous operations.

The downlink transmissions described herein may also be called forward link transmissions while the uplink transmissions may also be called reverse link transmissions. Each communication link described herein—including, for example, wireless communications system 100 and 200 of FIGS. 1 and 2—may include one or more carriers, where each carrier may be a signal made up of multiple sub-carriers (e.g., waveform signals of different frequencies).

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above may be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable read only memory (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, digital subscriber line (DSL), or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. An apparatus for wireless communication, in a system comprising:
a processor;
memory in electronic communication with the processor; and
instructions stored in the memory and operable, when executed by the processor, to cause the apparatus to:
determine a parameter value for each of a plurality of beamformee devices;
compare each of the determined parameter values to a stationary metric to identify a first subset of the beamformee devices that satisfy the stationary metric and a second subset of the beamformee devices that fail to satisfy the stationary metric;
determine not to perform a sounding procedure with each beamformee device in the first subset and to perform the sounding procedure with each beamformee device in the second subset;
generate a targeted sounding announcement that includes a plurality of identifiers that respectively correspond to each beamformee device in the second subset; and
transmit the targeted sounding announcement to initiate the sounding procedure with each beamformee device in the second subset.

2. The apparatus of claim 1, wherein the instructions are further executable by the processor to:
receive a sounding response from a beamformee device of the second subset;
update a steering matrix based at least in part on the sounding response; and
communicate with the beamformee device of the second subset using the updated steering matrix.

3. The apparatus of claim 1, wherein the instructions are further executable by the processor to:
generate a steering matrix for a first beamformee device of the plurality of beamformee devices;
determine not to update the steering matrix based at least in part on the first beamformee device satisfying the stationary metric; and
communicate with the first beamformee device using the steering matrix subsequent to completion of the sounding procedure.

4. The apparatus of claim 3, wherein the instructions are further executable by the processor to:
determine that a time period has elapsed since the steering matrix was generated;
generate a second targeted sounding announcement that includes an identifier of the first beamformee device; and
transmit the second targeted sounding announcement to initiate a second sounding procedure with the first beamformee device.

5. The apparatus of claim 1, wherein the instructions are further executable by the processor to:
determine a second parameter value for each of the plurality of beamformee devices;
compare each of the second parameter values to the stationary metric to identify that all of the beamformee devices satisfy the stationary metric; and
increase a sounding interval to delay when a second sounding procedure is initiated based at least in part on identifying that all of the beamformee devices satisfy the stationary metric.

6. The apparatus of claim 5, wherein the instructions are further executable by the processor to:
apply an exponential backoff algorithm for determining the increase to the sounding interval.

7. The apparatus of claim 5, wherein the increase to the sounding interval is based at least in part on a defined amount or a factor of the defined amount.

8. The apparatus of claim 1, wherein the instructions are further executable by the processor to:
generate an initial sounding announcement that includes an identifier of each of the beamformee devices; and
calculate a steering matrix for each of the beamformee devices.

9. The apparatus of claim 8, wherein the determined parameter values correspond to a rate of change of a steering matrix of the steering matrices and a downlink packet error rate of respective ones of the beamformee devices.

10. The apparatus of claim 1, wherein the parameter value corresponds to:
a rate of change of a steering matrix, or
a downlink packet error rate, or
channel feedback, or
an age of the steering matrix, or
any combination thereof.

11. The apparatus of claim 1, wherein the stationary metric corresponds to:
a rate of change threshold of a steering matrix, or
a downlink packet error rate threshold, or
a data rate threshold, or
a signal to noise ratio threshold, or
a layer threshold, or
an age of the steering matrix threshold, or
any combination thereof.

12. The apparatus of claim 1, wherein the instructions are further executable by the processor to:
adjust when to perform a second sounding procedure based at least in part on determining that a first beamformee device of the plurality of beamformee devices of the first subset no longer satisfies the stationary metric.

13. The apparatus of claim 12, wherein adjusting when to perform on the second sounding procedure further comprises:
immediately triggering of the second sounding procedure.

14. The apparatus of claim 12, wherein adjusting when to perform on the second sounding procedure further comprises:
decreasing a sounding interval.

15. A method for wireless communication, comprising:
determining a parameter value for each of a plurality of beamformee devices;
comparing each of the determined parameter values to a stationary metric to identify a first subset of the beamformee devices that satisfy the stationary metric and a second subset of the beamformee devices that fail to satisfy the stationary metric;
determining not to perform a sounding procedure with each beamformee device in the first subset and to perform the sounding procedure with each beamformee device in the second subset;
generating a targeted sounding announcement that includes a plurality of identifiers that respectively correspond to each beamformee device in the second subset; and
transmitting the targeted sounding announcement to initiate the sounding procedure with each beamformee device in the second subset.

16. The method of claim 15, further comprising:
receiving a sounding response from a beamformee device of the second subset;
updating a steering matrix based at least in part on the sounding response; and
communicating with the beamformee device of the second subset using the updated steering matrix.

17. The method of claim 15, further comprising:
generating a steering matrix for a first beamformee device of the plurality of beamformee devices;
determining not to update the steering matrix based at least in part on the first beamformee device satisfying the stationary metric; and
communicating with the first beamformee device using the steering matrix subsequent to completion of the sounding procedure.

18. The method of claim 15, further comprising:
generating an initial sounding announcement that includes an identifier of each of the beamformee devices; and
calculating a steering matrix for each of the beamformee devices.

19. The method of claim 18, wherein the determined parameter values correspond to a rate of change of a steering matrix of the steering matrices and a downlink packet error rate of respective ones of the beamformee devices.

20. The method of claim 15, wherein the parameter value corresponds to:
a rate of change of a steering matrix, or
a downlink packet error rate, or
channel feedback, or
an age of the steering matrix, or
any combination thereof.

21. The method of claim 15, wherein the stationary metric corresponds to:
a rate of change threshold of a steering matrix, or
a downlink packet error rate threshold, or
a data rate threshold, or
a signal to noise ratio threshold, or
a layer threshold, or
an age of the steering matrix threshold, or
any combination thereof.

22. The method of claim 15, further comprising:
adjusting when to perform a second sounding procedure based at least in part on determining that a first beamformee device of the plurality of beamformee devices of the first subset no longer satisfies the stationary metric.

23. An apparatus for wireless communication, comprising:
a parameter determiner to determine a parameter value for each of a plurality of beamformee devices;
a stationary identifier component to compare each of the determined parameter values to a stationary metric to identify a first subset of the beamformee devices that satisfy the stationary metric and a second subset of the beamformee devices that fail to satisfy the stationary metric, and to determine not to perform a sounding procedure with each beamformee device in the first subset and to perform the sounding procedure with each beamformee device in the second subset; and
a sounding component to generate a targeted sounding announcement that includes a plurality of identifiers that respectively correspond to each beamformee device in the second subset, and to transmit the targeted sounding announcement to initiate the sounding procedure with each beamformee device in the second subset.

24. The apparatus of claim 23, further comprising:
the sounding component to receive a sounding response from a beamformee device of the second subset;
a steering matrix generator to update a steering matrix based at least in part on the sounding response; and
the sounding component to communicate with the beamformee device of the second subset using the updated steering matrix.

25. The apparatus of claim 23, further comprising:
a steering matrix generator to generate a steering matrix for a first beamformee device of the plurality of beamformee devices and to determine not to update the steering matrix based at least in part on the first beamformee device satisfying the stationary metric; and
the sounding component to communicate with the first beamformee device using the steering matrix subsequent to completion of the sounding procedure.

26. The apparatus of claim 25, further comprising:
a timing component to determine that a time period has elapsed since the steering matrix was generated; and
the sounding component to generate a second targeted sounding announcement that includes an identifier of the first beamformee device and communicate the second targeted sounding announcement to initiate a second sounding procedure with the first beamformee device.

27. The apparatus of claim 23, further comprising:
the stationary identifier component to:
identify a second parameter value for each of the plurality of beamformee devices,
compare each of the second parameter values to the stationary metric to identify that all of the beamformee devices satisfy the stationary metric, and
increase a sounding interval to delay when a second sounding procedure is initiated based at least in part on identifying that all of the beamformee devices satisfy the stationary metric.

28. A non-transitory computer-readable medium storing code for wireless communication, the code comprising instructions executable by a processor to:
determine a parameter value for each of a plurality of beamformee devices;
compare each of the determined parameter values to a stationary metric to identify a first subset of the beamformee devices that satisfy the stationary metric and a second subset of the beamformee devices that fail to satisfy the stationary metric;
determine not to perform a sounding procedure with each beamformee device in the first subset and to perform the sounding procedure with each beamformee device in the second subset;
generate a targeted sounding announcement that includes a plurality of identifiers that respectively correspond to each beamformee device in the second subset; and
transmit the targeted sounding announcement to initiate the sounding procedure with each beamformee device in the second subset.

29. The non-transitory computer-readable medium of claim 28, wherein the instructions are further executable by the processor to:
receive a sounding response from a beamformee device of the second subset;
update a steering matrix based at least in part on the sounding response; and
communicate with the beamformee device of the second subset using the updated steering matrix.

30. The non-transitory computer-readable medium of claim 28, wherein the instructions are further executable by the processor to:
determine a second parameter value for each of the plurality of beamformee devices;
compare each of the second parameter values to the stationary metric to identify that all of the beamformee devices satisfy the stationary metric; and
increase a sounding interval to delay when a second sounding procedure is initiated based at least in part on determining that all of the beamformee devices satisfy the stationary metric.
